(19) United States
(12) Patent Application Publication
(10) Pub. No.: US 2025/0024432 A1
(43) Pub. Date: Jan. 16, 2025

(54) FIRST WIRELESS COMMUNICATION DEVICE AND SECOND WIRELESS COMMUNICATION DEVICE

(71) Applicant: FUJITSU LIMITED, Kawasaki-shi (JP)

(72) Inventors: Yoshiaki OHTA, Yokohama (JP); YOSHIHIRO KAWASAKI, Kawasaki (JP); Tetsuya YANO, Yokohama (JP)

(73) Assignee: FUJITSU LIMITED, Kawasaki-shi (JP)

(21) Appl. No.: 18/829,524

(22) Filed: Sep. 10, 2024

Related U.S. Application Data
(63) Continuation of application No. PCT/JP2022/011603, filed on Mar. 15, 2022.

(51) Int. Cl. H04W 72/04; H04W 72/12

(52) U.S. Cl. CPC H04W 72/04; H04W 72/12

(57) ABSTRACT

A first wireless communication device that performs pre-allocated communication to communicate with a second wireless communication device, using a preconfigured radio resource, includes a controller configured to receive data transmitted on an adjusted radio resource obtained by adjusting a timing of a preconfigured pre-allocated radio resource to a predetermined different timing.

### CROSS-REFERENCE TO RELATED APPLICATION

This application is a continuation application of International Application PCT/JP2022/011603 filed on Mar. 15, 2022 and designated the U.S., the entire contents of which are incorporated herein by reference.

### FIELD

The embodiments discussed herein are related to a first wireless communication device and a second wireless communication device.

### BACKGROUND

Wireless communication systems using wireless technologies are used these days. Wireless communication systems are used in facilities such as factories, for example.

In a factory, manufacturing equipment and devices are wirelessly connected to a controlled monitoring system, and data and control signals are transmitted and received using Internet of Things (IoT), for example. The IoT used in factories is referred to as Industrial IoT (IIoT) in some cases, for example.

In IIoT, for example, the terminal device side configures a network, and the GW (UE-GW) on the terminal device side is responsible for communication in some cases. Traffic (data) in a terminal device is periodically (as planned) generated (periodic deterministic traffic (PDT)), for example. The traffic is transmitted on a radio resource of a configured grant (CG) (hereinafter referred to as a CG resource in some cases) in uplink wireless transmission, and with semi-persistent scheduling (SPS) in downlink wireless transmission, for example.

Technologies related to IIOT are described in the following related art documents.

3GPP TS36.133 LTE-A Radio Measurement Specification, 3GPP TS36.300 LTE-A General Specification, 3GPP TS36.211 LTE-A PHY Channel Specification, 3GPP TS36.212 LTE-A PHY Coding Specification, 3GPP TS36.213 LTE-A PHY Procedure Specification, 3GPP TS36.214 LTE-A PHY Measurement Specification, 3GPP TS36.321 LTE-A MAC Specification, 3GPP TS36.322 LTE-A RLC Specification, 3GPP TS36.323 LTE-A PDCP Specification, 3GPP TS36.331 LTE-A RRC Specification, 3GPP TS36.413 LTE-A S1 Specification, 3GPP TS36.423 LTE-A X2 Specification, 3GPP TS36.425 LTE-A Xn Specification, 3GPP TR36.912 NR Radio Access Overview, 3GPP TR38.913 NR Requirements, 3GPP TR38.801 NR Network Architecture Overview, 3GPP TR38.802 NR PHY Overview, 3GPP TR38.803 NR RF Overview, 3GPP TR38.804 NR L2 Overview, 3GPP TR38.900 NR High Frequency Overview, 3GPP TS38.300 NR General Specification, 3GPP TS37.340 NR Multi-Connectivity General Specification, 3GPP TS38.201 NR PHY Specification General Specification, 3GPP TS38.202 NR PHY Service General Specification, 3GPP TS38.211 NR PHY Channel Specification, 3GPP TS38.212 NR PHY Coding Specification, 3GPP TS38.213 NR PHY Data Channel Procedure Specification, 3GPP TS38.214 NR PHY Control Channel Procedure Specification, 3GPP TS38.215 NR PHY Measurement Specification, 3GPP TS38.321 NR MAC Specification, 3GPP TS38.322 NR RLC Specification, 3GPP TS38.323 NR PDCP Specification, 3GPP TS37.324 NR SDAP Specification, 3GPP TS38.331 NR RRC Specification, 3GPP TS38.401 NR Architecture General Specification, 3GPP TS38.410 NR Core Network General Specification, 3GPP TS38.413 NR Core Network AP Specification, 3GPP TS38.420 NR Xn Interface General Specification, 3GPP TS38.423 NR XnAP Specification, 3GPP TS38.470 NR F1 Interface General Specification, and 3GPP TS38.473 NR F1AP Specification are disclosed as related art.

In a terminal device, however, traffic might arrive at a timing (a quasi-periodic timing) that is not the periodic timing (aperiodic deterministic traffic: ADT). In this case, it might not be possible to perform transmission with the CG described above. Therefore, it is considered that CG resources are allocated to timings to transmit ADT data not at the periodic timings, or radio resources of a dynamic grant (DG) are allocated. By such schemes, however, efficiency of use of radio resources drops due to allocation of many CG resources not to be used, and an overhead or the like in a control signal monitoring process occurs due to execution of an allocation sequence when a DG radio resource (hereinafter referred to as a DG resource in some cases) is used.

Therefore, the embodiments discussed herein provide a first wireless communication device and a second wireless communication device that reduce the decrease in efficiency of use of radio resources and the overhead due to the monitoring process in transmission of ADT data.

### SUMMARY

According to an aspect of the embodiments, a first wireless communication device that performs pre-allocated communication to communicate with a second wireless communication device, using a preconfigured radio resource, the first wireless communication device includes a controller configured to receive data transmitted on an adjusted radio resource obtained by adjusting a timing of a preconfigured pre-allocated radio resource to a predetermined different timing.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIGS. 1A and 1B are diagrams illustrating an example of wireless communication in a wireless communication system 3;

FIG. 2 is a diagram illustrating an example of radio resources;

FIG. 3 is a diagram illustrating an example configuration of a wireless communication system 10;

FIG. 4 is a diagram illustrating an example configuration of a base station device 200;

FIG. 5 is a diagram illustrating an example of the radio resources in a DG pre-allocation scheme;

FIG. 6 is a diagram illustrating an example of the radio resources in a multiple CG pre-allocation scheme;

FIG. 7 is a diagram illustrating an example of the radio resources in a CG shift scheme;

FIGS. 8A and 8B are diagrams illustrating an example of processing procedures according to the CG shift scheme in a terminal device 100;

FIGS. 9A and 9B are diagrams illustrating an example of processing procedures according to the CG shift scheme in the base station device 200;

FIGS. 10A to 10C are diagrams illustrating an example of each frame configuration;

FIGS. 11A and 11B are diagrams each illustrating an example of the configuration of mapping of a logical channel (LCH);

FIG. 12 is a diagram illustrating an example of a system operation of the base station device 200 and terminal devices 100;

FIG. 13 is a diagram illustrating an example of radio resources including resources that are not to be shifted;

FIG. 14 is a diagram illustrating an example in which a control signal is transmitted every time a shift is performed;

FIG. 15 is a diagram illustrating an example in which a physical random access channel (PRACH) is a control signal;

FIG. 16 is a diagram illustrating an example in which a control signal is not transmitted; and

FIG. 17 is a diagram illustrating an example of the value of a configured grant timer (CGT).

### DESCRIPTION OF EMBODIMENTS

### First Embodiment

A first embodiment is now described.

A wireless communication system 3 is a wireless communication system that includes a first wireless communication device 1 and a second wireless communication device 2. The first wireless communication device 1 and the second wireless communication device 2 wirelessly perform communication. In the wireless communication system 3, the first wireless communication device 1 and the second wireless communication device 2 perform pre-allocated communication by transmitting and receiving data using a radio resource that has been configured in advance.

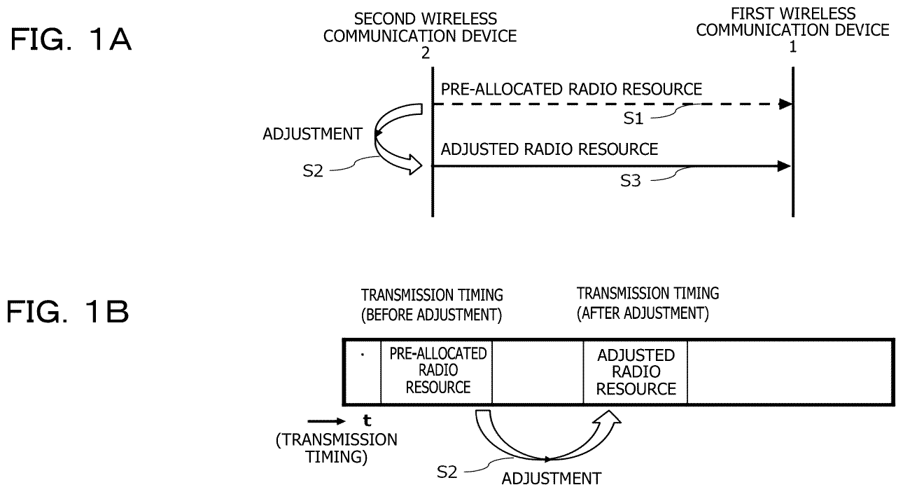

FIGS. 1A and 1B are diagrams illustrating an example of wireless communication in the wireless communication system 3. FIG. 1A is a diagram illustrating an example of a sequence in which data is transmitted from the second wireless communication device 2 to the first wireless communication device 1.

The second wireless communication device 2 transmits data to the first wireless communication device 1, using a radio resource that has been allocated beforehand (hereinafter referred to as a pre-allocated radio resource in some cases) (S1). However, in a case where the second wireless communication device 2 is not able to transmit data using the pre-allocated radio resource (such as a case where data will not arrive in time, for example), the second wireless communication device 2 does not use the pre-allocated radio resource (S1). The second wireless communication device 2 then adjusts the timing of transmission of the pre-allocated radio resource to a later time (S2), and configures an adjusted radio resource. The second wireless communication device 2 transmits data to the first wireless communication device 1, using the adjusted radio resource (S3).

FIG. 1B is a diagram illustrating an example of radio resources. In FIG. 1B, the horizontal axis of the radio resources indicates time (transmission timing). The second wireless communication device 2 adjusts (shifts backward in the time axis, for example) the timing of transmission (unadjusted timing of transmission) of the pre-allocated radio resource (S2), and configures the timing of transmission (the adjusted timing of transmission) of the adjusted radio resource. Note that the pre-allocated radio resource and the adjusted radio resource may be in the same frequency band, for example.

In the first embodiment, the timing of transmission of a pre-allocated radio resource is adjusted, and data is transmitted on the adjusted radio resource. As a result, the wireless communication system 3 can transmit delayed data, without performing a new allocation process, and further, without allocating a plurality of pre-allocated radio resources beforehand.

### Second Embodiment

A second embodiment is now described.

### <Wireless Communication System 10>

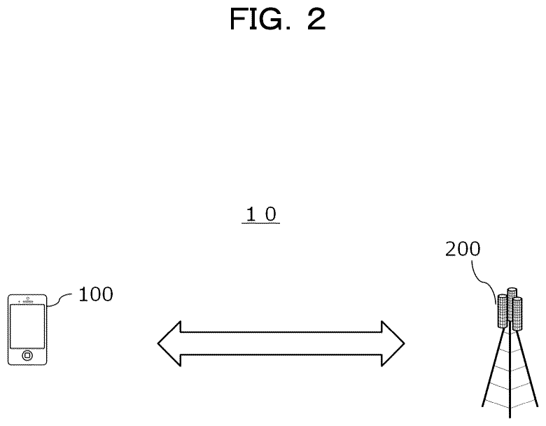

FIG. 2 is a diagram illustrating an example configuration of a wireless communication system 10. The wireless communication system 10 includes a base station device 200 and a terminal device 100. The wireless communication system 10 is a wireless communication system that is installed in a system and is compatible with IIOT, for example.

The terminal device 100 is a communication device attached to equipment (a device) in the system. The base station device 200 is a communication device installed in the system.

For example, the base station device 200 is compatible with various generations of communication (such as 5G or Beyond 5G, for example). Further, the base station device 200 may be formed with one device, or may be formed with a plurality of devices such as a central unit (CU) and a distributed unit (DU).

The terminal device 100 periodically transmits data to the base station device 200, for example. The terminal device 100 uses radio resources of CG in the periodic (PDT) data transmission. Further, the terminal device 100 is also compatible with aperiodic (ADT) data transmission. The aperiodic data transmission includes data transmission that occurs with a delay from the periodic data transmission timing, for example.

Note that there is one terminal device 100 in FIG. 2, but there may be a plurality of terminal devices. Further, in the following embodiments, data transmission from the terminal device 100 to the base station device 200 will be described as an example. However, similar processing can also be applied to communication between the terminal devices 100, and data transmission from the base station device 200 to the terminal devices 100.

### <Example Configuration of a Terminal Device 100>

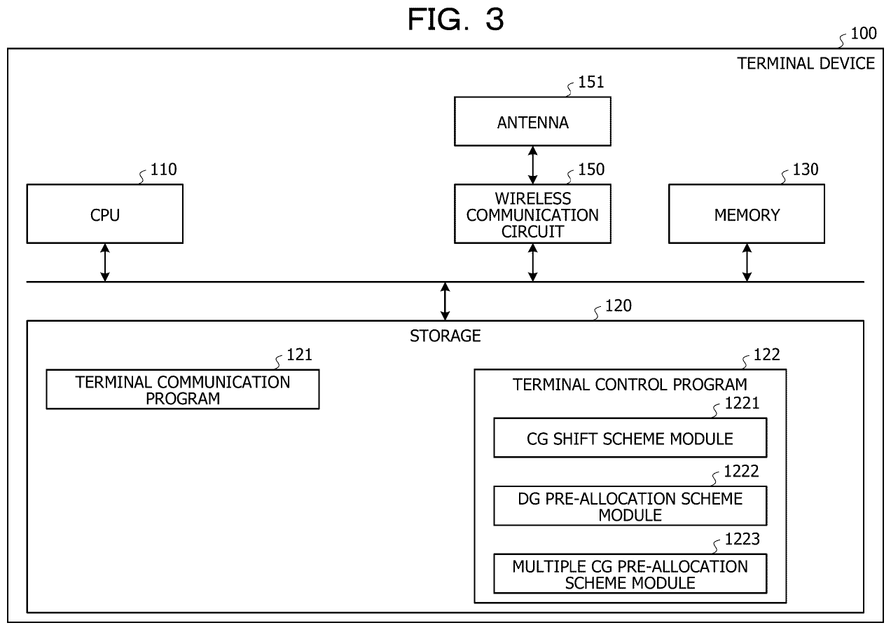

FIG. 3 is a diagram illustrating an example configuration of a terminal device 100. The terminal device 100 includes a central processing unit (CPU) 110, a storage 120, a memory 130, a wireless communication circuit 150, and an antenna 151.

The storage 120 is an auxiliary storage device that stores programs and data, such as a flash memory, a hard disk drive (HDD), or a solid state drive (SSD). The storage 120 stores a terminal communication program 121 and a terminal control program 122.

The memory 130 is an area into which a program stored in the storage 120 is loaded. Also, the memory 130 may be used as an area into which a program stores data.

The wireless communication circuit 150 is a device that performs wireless communication with the base station device 200 and other terminal devices 100. The wireless communication circuit 150 has the antenna 151. The antenna 151 includes a directional antenna capable of controlling directions of transmission and reception of radio waves, for example.

The CPU 110 is a processor that loads a program stored in the storage 120 into the memory 130, and executes the loaded program, to build each component and implement each process.

By executing the terminal communication program 121, the CPU 110 constructs a second communication unit, and performs a terminal communication process. The terminal communication process is a process of performing wireless communication with the base station device 200 or another terminal device 100.

By executing the terminal control program 122, the CPU 110 constructs a second control unit, and performs a terminal control process. The terminal control process is a process of controlling wireless communication with the terminal device 100. In the terminal control process, the terminal device 100 performs PDT data transmission or ADT data transmission, for example. The terminal device 100 has a DG pre-allocation scheme, a multiple CG pre-allocation scheme, and a CG shift scheme as the ADT data transmission schemes, for example. Each of these schemes will be described later in detail.

Note that the terminal device 100 does not necessarily have the three schemes, and may have only the CG shift scheme, or may have the CG shift scheme and one of the other schemes, for example.

By executing a CG shift scheme module 1221 included in the terminal control program 122, the CPU 110 constructs the second control unit, and performs a CG shift scheme process. The CG shift scheme process is a process of transmitting ADT data by the CG shift scheme.

By executing a DG pre-allocation scheme module 1222 included in the terminal control program 122, the CPU 110 constructs the second control unit, and performs a DG pre-allocation scheme process. The DG pre-allocation scheme process is a process of transmitting ADT data by the DG pre-allocation scheme.

By executing a multiple CG pre-allocation scheme module 1223 included in the terminal control program 122, the CPU 110 constructs the second control unit, and performs a multiple CG pre-allocation scheme process. The multiple CG pre-allocation scheme process is a process of transmitting ADT data by the multiple CG pre-allocation scheme.

### <Example Configuration of the Base Station Device 200>

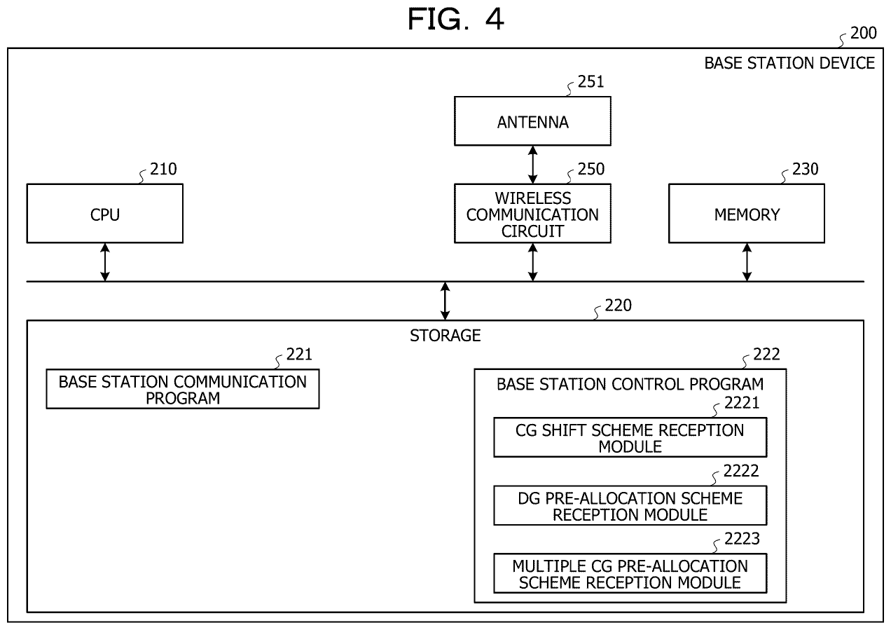

FIG. 4 is a diagram representing an example configuration of the base station device 200. The base station device 200 includes a CPU 210, a storage 220, a memory 230, a wireless communication circuit 250, and an antenna 251.

The storage 220 is an auxiliary storage device that stores programs and data, such as a flash memory, an HDD, or an SSD. The storage 220 stores a base station communication program 221 and a base station control program 222.

The memory 230 is an area into which a program stored in the storage 220 is loaded. Also, the memory 230 may be used as an area into which a program stores data.

The wireless communication circuit 250 is a device that performs wireless communication with a terminal device 100. The wireless communication circuit 250 has the antenna 251. The antenna 251 includes a directional antenna capable of controlling directions of transmission and reception of radio waves, for example.

The CPU 210 is a processor that loads a program stored in the storage 220 into the memory 230, and executes the loaded program, to build each component and implement each process.

By executing the base station communication program 221, the CPU 210 constructs a communication unit, and performs a communication process. The base station communication process is a process of performing wireless communication with a terminal device 100. In the base station communication process, the base station device 200 is wirelessly connected to the terminal device 100, transmits data and a control signal to the terminal device 100, and receives data from the terminal device 100.

By executing the base station control program 222, the CPU 210 constructs a control unit, and performs a base station control process. The base station control process is a process of controlling wireless communication being performed by the base station device 200. In the base station control process, the base station device 200 performs PDT data reception or ADT data reception, for example. The base station device 200 performs reception compatible with the ADT data transmission scheme in the terminal device 100.

By executing a CG shift scheme reception module 2221 included in the base station control program 222, the CPU 210 constructs the control unit, and performs a CG shift scheme reception process. The CG shift scheme reception process is a process of receiving ADT data transmitted by the CG shift scheme.

By executing a DG pre-allocation scheme reception module 2222 included in the base station control program 222, the CPU 210 constructs the control unit, and performs a DG pre-allocation scheme reception process. The DG pre-allocation scheme reception process is a process of receiving ADT data transmitted by the DG pre-allocation scheme.

By executing a multiple CG pre-allocation scheme reception module 2223 included in the base station control program 222, the CPU 210 constructs the control unit, and performs a multiple CG pre-allocation scheme reception process. The multiple CG pre-allocation scheme reception process is a process of receiving ADT data transmitted by the multiple CG pre-allocation scheme.

### <Radio Resources at a Time of ADT Data Generation>

A radio resource allocation scheme at a time of ADT data generation is now described. In the description below, each allocation scheme is explained.

### <1. DG Pre-Allocation Scheme>

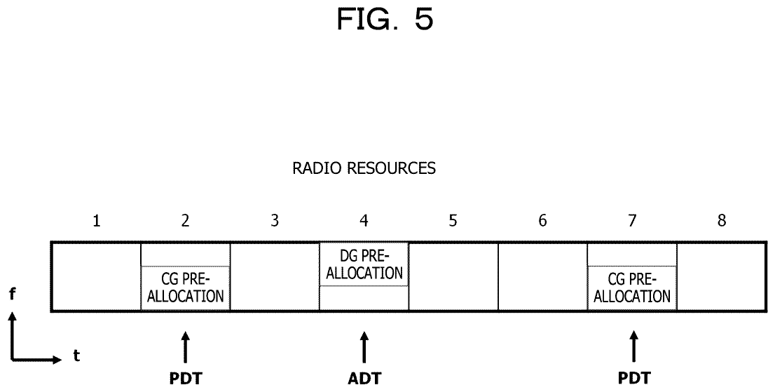

FIG. 5 is a diagram illustrating an example of the radio resources in the DG pre-allocation scheme. In FIG. 5, the vertical direction indicates frequency (f), and the horizontal direction indicates time (t). Also, In FIG. 5, the radio resources are divided in units of slots, and the above numerical values in the upper portion indicate slot numbers. Further, in FIG. 5, periodic transmission of PDT data is performed in five-slot cycles, and CG resources allocated beforehand are used. The subsequent drawings regarding radio resources are the same as FIG. 5, unless otherwise specified.

In the DG pre-allocation scheme, DG resources are allocated beforehand for transmission of ADT data. PDT data is periodically transmitted in slots 2 and 7. Further, as a radio resource for transmitting ADT data, a DG resource is allocated beforehand to slot 4 (two slots after a CG resource for PDT data transmission).

The terminal device 100 transmits data using the DG resource allocated to slot 4, in a case where PDT data is not able to be transmitted in slot 2 due to a delay in the arrival of traffic, a case where new data is generated, or the like, for example.

To use the DG resource, or to receive a UL grant (a radio resource allocation procedure) using scheduling requests (SR)/a physical downlink control channel (PDCCH), for example, the terminal device 100 carries out an SR procedure with the base station device 200.

In the DG pre-allocation scheme, the base station device 200 and the terminal device 100 monitor messages transmitted and received in the radio resource allocation procedure, resulting in an increase the processing load. Furthermore, since the radio resource allocation procedure is carried out, a time constraint also occurs.

### <2. Multiple CG Pre-Allocation Scheme>

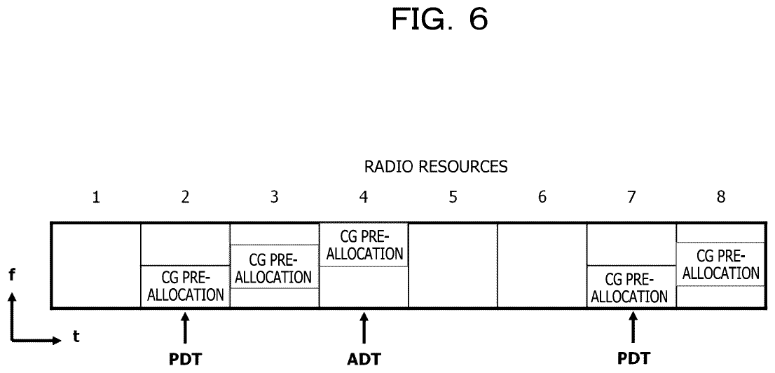

FIG. 6 is a diagram illustrating an example of the radio resources in the multiple CG pre-allocation scheme.

In the multiple CG pre-allocation scheme, in addition to the CG resources (slots 2 and 7) allocated for transmission of PDT data, CG resources are allocated beforehand for transmission of ADT data. For example, the CG resources for ADT data transmission are allocated beforehand to slots 3 and 4 (one slot after and two slots after a CG resource for PDT data transmission).

The terminal device 100 transmits data using the CG resource allocated to slot 3, in a case where PDT data is not able to be transmitted in slot 2 due to a delay in the arrival of traffic, a case where new data is generated, or the like, for example. Further, in a case where data is not able to be transmitted on the CG resource in slot 3, the terminal device 100 transmits data using the CG resource in the slot 4.

In the multiple CG pre-allocation scheme, in a case where ADT data is not generated, the CG resources for ADT data transmission are not used. However, since the unused CG resources are not able to be used by any other terminal device 100 and the like, the efficiency of use of the radio resources in the wireless communication system 10 drops.

### <3. CG Shift Scheme>

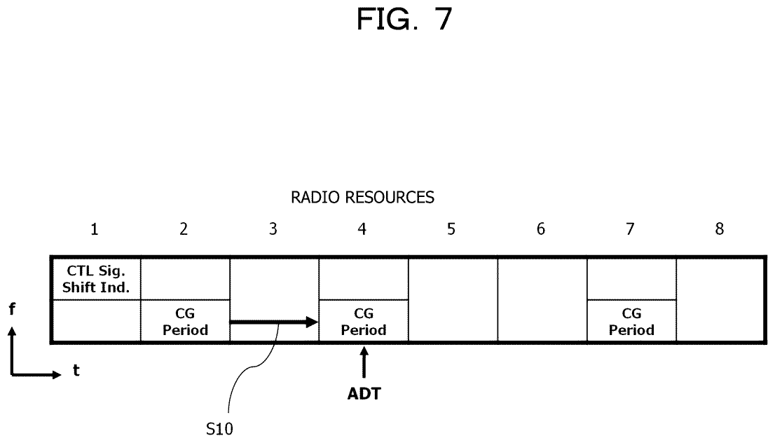

FIG. 7 is a diagram illustrating an example of the radio resources in the CG shift scheme.

In the CG shift scheme, CG resources for PDT data transmission whose time direction (slot number) is shifted within a PDT cycle are used as radio resources for ADT data transmission.

The terminal device 100 recognizes that data is not able to be transmitted on the CG resource in slot 2 for PDT data transmission (and that ADT data is generated). The terminal device 100 shifts the CG resource for PDT data transmission in slot 2 in accordance with the shift amount (equivalent to two slots) (S10), and secures a CG resource for ADT data transmission in slot 4.

The shift amount is configured beforehand between the terminal device 100 and the base station device 200, for example. Further, in a case where one shift amount is selected from among a plurality of shift amount candidates, the terminal device 100 may incorporate the selected shift amount into a control signal and then transmit the control signal.

Since data is not able to be transmitted on the CG resource in slot 2, the terminal device 100 notifies that the CG resource for PDT data transmission is to be shifted, through a control signal (CTL Sig. Shift Ind.) in slot 1 before slot 2. The terminal device 100 then transmits ADT data using the secured CG resource in slot 4.

Receiving the control signal, the base station device 200 recognizes that a shift of the CG resource is to occur, receives the CG resource at the timing corresponding to the shift amount, and acquires the ADT data. Note that, in a case where the resource of the shift destination of a CG resource has been allocated to another terminal device or the like, the base station device 200 may cancel the radio resource allocated to the another terminal device, and prioritize the shift of the CG resource.

The terminal device 100 transmits subsequent PDT data (PDT data after slot 7) in accordance with cycles (every five slots), unless new ADT data is generated.

In the CG shift scheme, CG resources for ADT data transmission are not allocated. Accordingly, there are no unused CG resources, and thus, a decrease in efficiency of radio resources can be avoided. Also, in the CG shift scheme, a CG resource for PDT data is shifted when ADT data is generated. Accordingly, any allocation procedure like those for DG resources does not occur, and thus, an increase in the processing load can be avoided. In the description below, execution procedures according to the CG shift scheme are explained.

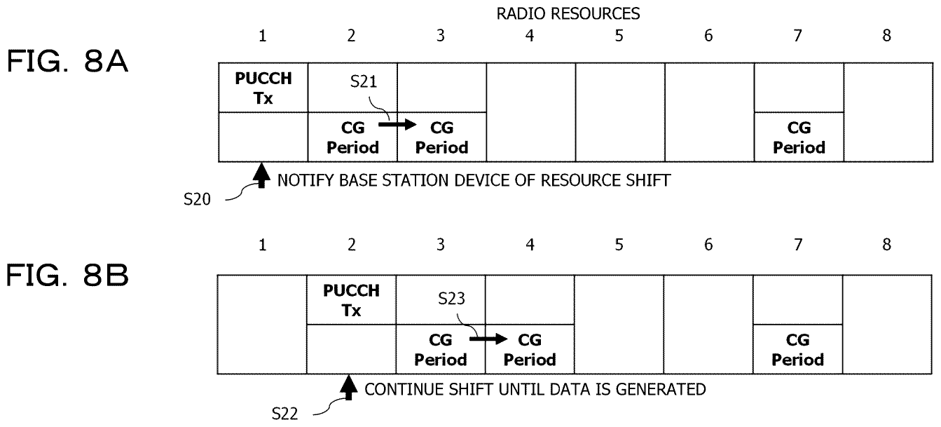

FIGS. 8A and 8B are diagrams illustrating an example of processing procedures according to the CG shift scheme in the terminal device 100. FIG. 8A is a diagram illustrating an example of the radio resources in a case where a shift occurs once. The terminal device 100 uses a physical uplink control channel (PUCCH) (control signal) in slot 1, to notify that a CG resource has been shifted (S20).

The terminal device 100 then shifts the CG resource in slot 2 to slot 3, in accordance with the shift amount (S21). The terminal device 100 transmits ADT data to the base station device 200, using the CG resource shifted to slot 3.

FIG. 8B is a diagram illustrating an example of the radio resources in a case where a shift occurs for the second time. In a case where data is not able to be transmitted (data is not generated) even on the CG resource shifted to slot 3 in FIG. 8A, the terminal device 100 further continues the shift (S22).

The terminal device 100 uses a PUCCH (control signal) in slot 2, to notify that the CG resource has been shifted.

The terminal device 100 then further shifts the CG resource shifted to slot 3 in FIG. 8A to slot 4, in accordance with the shift amount (S23). The terminal device 100 transmits ADT data to the base station device 200, using the CG resource shifted to slot 4. In this manner, the terminal device 100 continues a shift until data is generated.

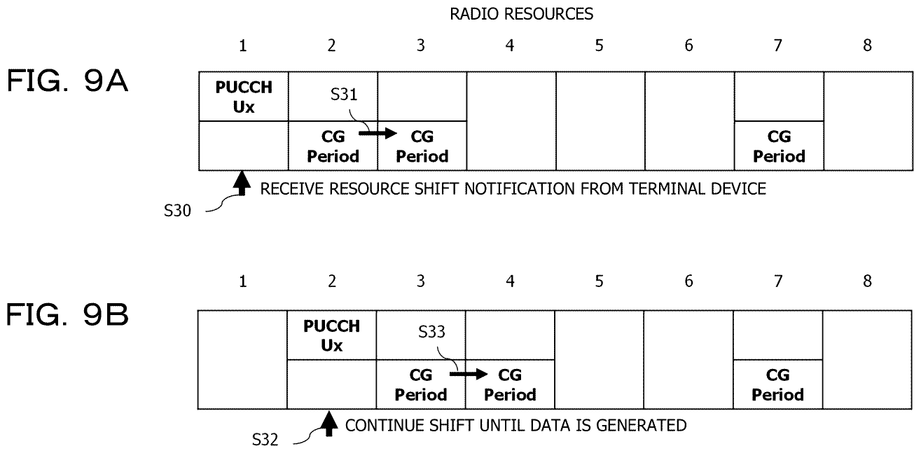

FIGS. 9A and 9B are diagrams illustrating an example of processing procedures according to the CG shift scheme in the base station device 200. FIG. 9A is a diagram illustrating an example of the radio resources in a case where a shift occurs once. The base station device 200 receives the PUCCH in slot 1 from the terminal device 100 (S30), and recognizes that the CG resource has been shifted.

The base station device 200 then awaits (monitors) data to be transmitted on the CG resource shifted to slot 3 by the terminal device 100 in accordance with the shift amount (S31). The terminal device 100 then receives the ADT data transmitted with the CG resource shifted to slot 3.

FIG. 9B is a diagram illustrating an example of the radio resources in a case where a shift occurs for the second time. In a case where data is not able to be transmitted (data is not generated) even on the CG resource the terminal device 100 has shifted to slot 3 in FIG. 9A, the base station device 200 further continues the shift (S32).

The base station device 200 receives the PUCCH (control signal) in slot 2, to recognize that the CG resource has been shifted.

The base station device 200 then awaits (monitors) the CG resource further shifted to slot 4 from the CG resource in slot 3 shifted by the terminal device 100. The terminal device 100 then receives the ADT data transmitted with the CG resource shifted to slot 4. In this manner, the base station device 200 continues a shift until data is generated.

### <Frame Configuration>

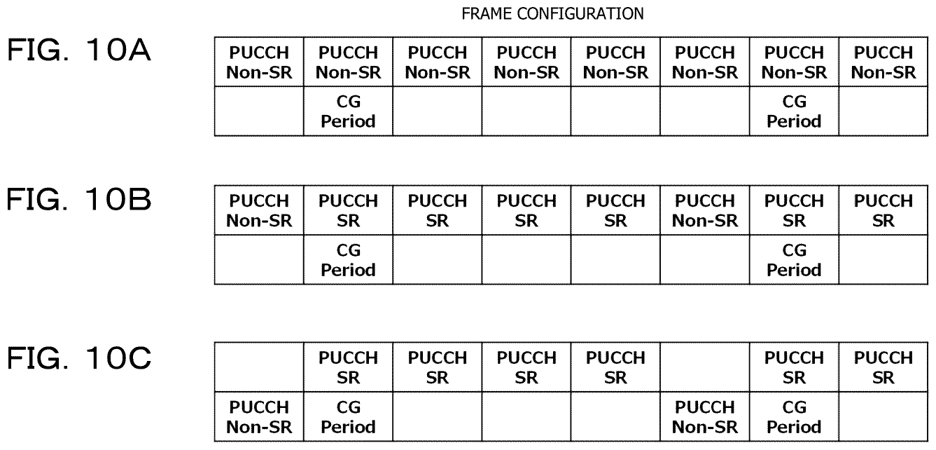

In the CG shift scheme, in a case where a PUCCH is used as a control signal, it is necessary to switch the PUCCH for SR or not. In the description below, frame configurations are explained. FIGS. 10A to 10C are diagrams illustrating an example of each frame configuration.

FIG. 10A is a diagram illustrating an example of a first frame configuration. The first frame configuration is a configuration in which all PUCCHs can be used as PUCCHs not for SR (PUCCH Non-SR). In the first frame configuration, a PUCCH for SR (PUCCH SR) and a PUCCH not for SR (PUCCH Non-SR) are switched with an RRC message, for example. Receiving a PUCCH Non-SR, the base station device 200 recognizes that no data has been generated (or that a shift occurs).

FIG. 10B is a diagram illustrating an example of a second frame configuration. The second frame configuration is a configuration in which a PUCCH a predetermined number of slots before a CG resource for PDT data transmission is a PUCCH Non-SR. The predetermined number is configured by RRC, for example, and is one slot in FIG. 10B. The resources for PUCCHs are common to SR and Non-SR. Receiving a PUCCH Non-SR, the base station device 200 can recognize that a shift occurs. Therefore, even in a case where the shift will continue thereafter, the base station device 200 only takes one resource for a PUCCH Non-SR in each cycle.

FIG. 10C is a diagram illustrating an example of a third frame configuration. In the third frame configuration, a dedicated resource for a PUCCH Non-SR is configured in a slot a predetermined number of slots before a CG resource for PDT data transmission. In a case where the transmission timings of a PUCCH Non-SR and a PUCCH SR overlap with each other, the terminal device 100 may give priority to transmission of the PUCCH Non-SR.

### <Proposed Configuration of LCH/SR Mapping>

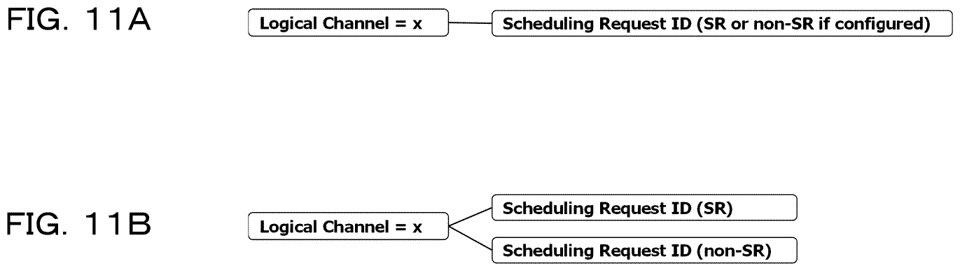

A configuration of mapping between a logical channel (LCH) and an SR is now described. FIGS. 11A and 11B are diagrams each illustrating an example of the configuration of mapping of an LCH.

FIG. 11A illustrates a configuration in which the identification (ID) of one SR corresponds to one LCH. The ID of an SR indicates either SR or Non-SR.

FIG. 11B illustrates a configuration in which the IDs of two SRs correspond to one LCH. The two IDs which are an SR ID indicating SR and an SR ID indicating Non-SR, correspond to an LCH X.

### <Cancellation and a Reallocation Process>

When the base station device 200 recognizes that the terminal device 100 shifts a CG resource in the CG shift scheme, if the resource overlapping the CG resource of the shift destination has been allocated to another terminal device, it is necessary to cancel the resource allocated to the another terminal device, and perform reallocation.

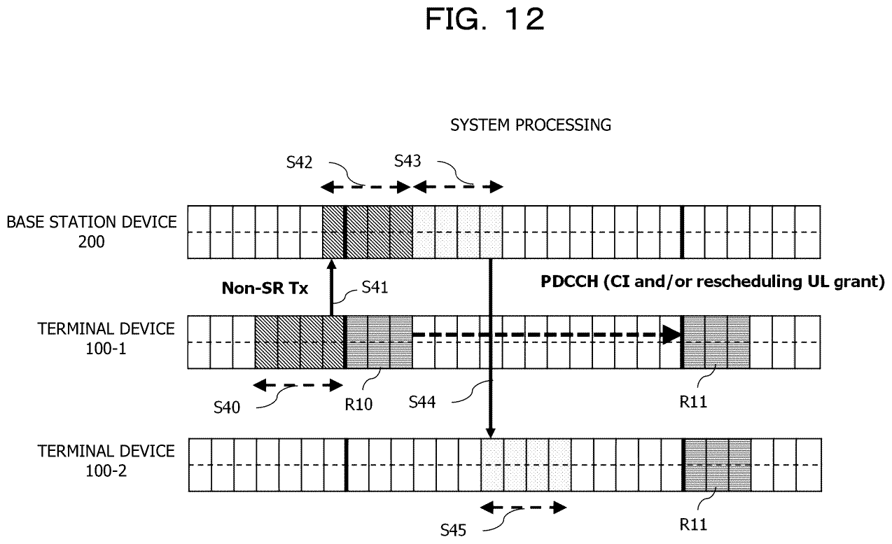

FIG. 12 is a diagram illustrating an example of a system operation of the base station device 200 and terminal devices 100. In FIG. 12, there are two terminal devices 100, which are terminal devices 100-1 and -2, respectively.

The terminal device 100-1 recognizes that the arrival of traffic is delayed, for example, determines to shift a CG resource R10 to a CG resource R11, and performs a PUCCH Non-SR transmission process of transmitting a PUCCH Non-SR to the base station device 200 (S40). For example, the terminal device 100-1 takes 4 sym processing units to perform the process S40. The processing units indicate the CPU processing cycle and the processing time that are to be taken for performing the processing, for example.

Receiving the PUCCH Non-SR (S41), the base station device 200 recognizes the shift, and performs a PUCCH Non-SR reception process (S42). For example, the base station device 200 takes 4 sym processing units to perform the process S42.

In a case where the radio resource of the shift destination of the CG resource has been allocated to the terminal device 100-2, the base station device 200 then performs a reallocation process of canceling the allocation of the radio resource of the shift destination to the terminal device 100-2, allocating a new radio resource, and notifying the terminal device 100-2 of the new radio resource (S43). For example, the base station device 200 takes 4 sym processing units to perform the process S43.

Receiving the notification of reallocation from the base station device 200 (S44), the terminal device 100-2 performs a reallocation reception process of canceling the originally allocated CG resource R11, and using (or storing the use of) the newly allocated radio resource (S45). For example, the terminal device 100-2 takes 4 sym processing units to perform the process S45.

As described above, a considerable processing time is to be taken since when a shift of a CG resource occurred in a terminal device 100 till a time when the base station device 200 cancels the CG resource of the shift destination allocated to another terminal device 100 and performs reallocation. Therefore, in a case where the CG shift scheme is adopted, it is necessary to satisfy the following Condition 1.

(TBS,rx)+(TBS,tx)+(TUE,rx)<CG resource shift interval Condition 1

(TBS, rx) indicates the processing time in the PUCCH Non-SR reception process in the base station device 200. (TBS, tx) indicates the processing time in the reallocation process in the base station device 200. (TUE, rx) indicates the processing time in the reallocation reception process in the terminal device 100 that is the reallocation target. The CG resource shift interval indicates a shift width (time) of a CG resource for PDT by a terminal device 100.

In the CG shift scheme, the shift width of the CG resources is adjusted to satisfy Condition 1 so that the reallocation process for another terminal device 100 can be performed in time. Note that, in a case where reallocation to another terminal device 100 is not performed, and only cancellation of the same resource (including partial overlapping) as the CG resource of the shift destination is performed, the reallocation process satisfying Condition 1 is replaced with a cancellation process.

### <Shift Width Limitation>

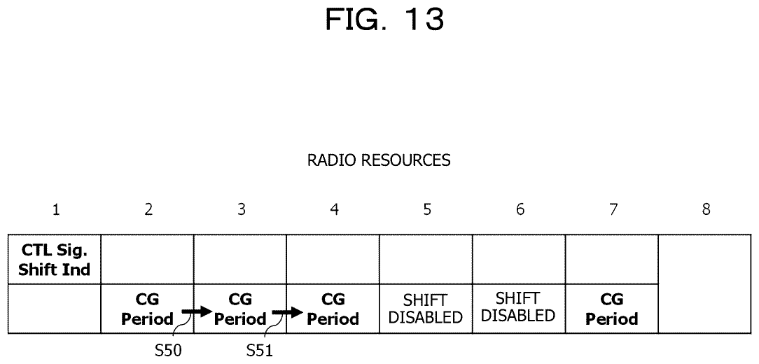

In the CG shift scheme, the shift width and the number of shifts for CG resources may be limited. FIG. 13 is a diagram illustrating an example of radio resources including resources that are not to be shifted. For example, a terminal device 100 sets to disable shifts in slots 5 and 6. As a result, the terminal device 100 can shift a CG resource from slot 2 to slot 3 (S50), and from slot 3 to slot 4 (S51), but does not further shift the CG resource to slots 5 and 6.

Note that FIG. 13 illustrates an example in which the shift amount is one slot, and the number of shifts is limited to two. However, in a case where the shift amount is two slots, and the number of shifts is limited to one, for example, shifts in slots 5 and 6 may also be set to be disabled.

In the CG shift scheme, the shift amount (width) and the number of shifts can be limited by disabling shifts in specific slots. Also, a terminal device 100 may directly limit the shift amount and the number of shifts. In any case, information regarding the limitation is shared with the base station device 200. Information sharing with the base station device 200 is performed through an RRC message or the like, for example. Also, the shift amount may be determined with reference to a parameter Burst Spread, for example.

### <Control Signal Transmission>

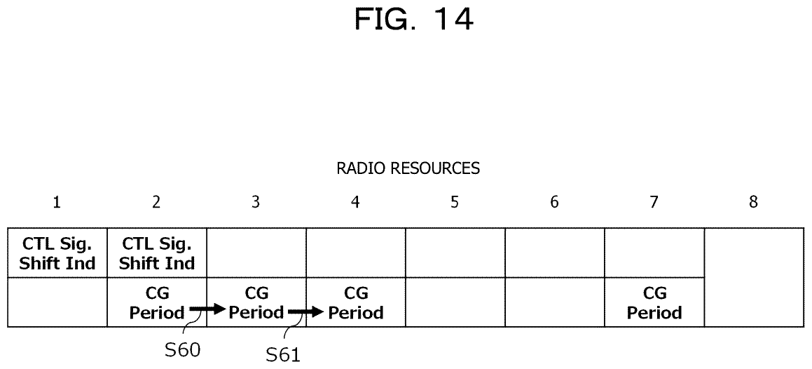

A control signal for sending a shift notification may be transmitted every time a shift is performed. FIG. 14 is a diagram illustrating an example in which a control signal is transmitted every time a shift is performed. When performing a shift process S60, a terminal device 100 transmits a control signal in slot 1. Further, when performing a shift process S61, the terminal device 100 transmits a control signal in slot 2.

As a result, the base station device 200 receives the control signal in slot 1, to recognize that the CG resource is to be shifted to slot 2. The base station device 200 then receives the control signal in slot 2, to recognize that the CG resource shifted to the slot 2 is to be further shifted to slot 3.

Note that the terminal device 100 may transmit a control signal only once. In this case, the base station device 200 recognizes that a shift is to be further performed if data is not able to be received in the slot at the shift destination.

As described above, by transmitting a control signal every time a shift occurs, it is possible to reliably notify the base station device 200 of each shift, even if a shift occurs a plurality of times.

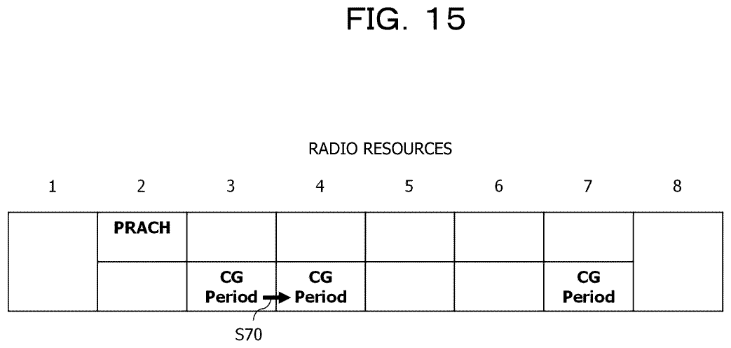

Also, a control signal may be a PRACH occupying a slot, instead of a PUCCH, for example. Either a slot or a preamble is allocated beforehand between the terminal device 100 and the base station device 200. FIG. 15 is a diagram illustrating an example in which a PRACH is a control signal. The terminal device 100 notifies that a shift process S70 is to occur, through a PRACH.

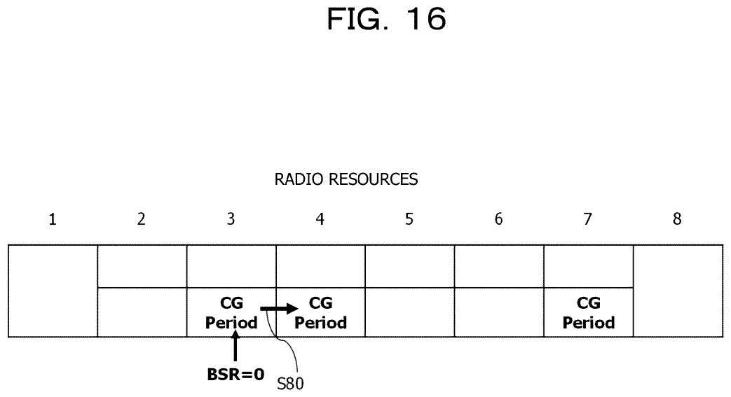

Further, the terminal device 100 may notify that a shift is to occur, without transmitting a control signal before the CG resource. FIG. 16 is a diagram illustrating an example in which a control signal is not transmitted. Instead, the terminal device 100 transmits a BSR=0 on the CG resource that is not used (S80). Receiving BSR=0, the base station device 200 recognizes that there is no data to be transmitted by the terminal device 100. The terminal device 100 may transmit a BSR=0, each time a shift is performed. By another method, it is determined that ADT traffic has occurred, when the base station device 200 does not receive a physical uplink shared channel (PUSCH) in a predetermined slot, based on the fact that a PUSCH is not transmitted in the predetermined slot in a case where ADT traffic has occurred in the terminal device 100. The terminal device 100 and the base station device 200 then perform a shift.

### <Timer Control>

A configured grant timer (CGT) is specified so as not to use other CG resources. After transmitting data using a CG resource, a terminal device 100 starts the CGT. The terminal device 100 continues the transmission of the corresponding data while the CGT is ongoing. For example, any other data is not able to overwrite the data (any other data does not overwrite the data held in a hybrid automatic repeat request (HARQ) buffer). If the start timing of the CGT deviates due to a shift, the next data might not be able to be transmitted using the CG resource in some cases. Therefore, in a case where a shifted CG resource is used, the terminal device 100 sets the initial value of the CGT to be negative by the amount of the shift, and then activates the CGT.

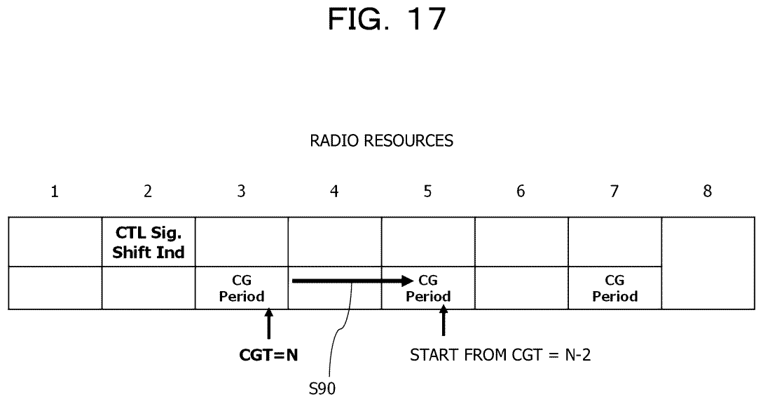

FIG. 17 is a diagram illustrating an example of the value of the CGT. The terminal device 100 shifts the CG resource in slot 3 to slot 5 (S90). The terminal device 100 activates the CGT with an initial value N in slot 3, but activates the CGT with an initial value N−2 obtained by subtracting the amount corresponding to the shift amount in slot 5. As a result, the activation time of the CGT is shortened, and the CG resource can be used in the next data transmission.

Note that the terminal device 100 may not set (may not start) the CGT in a case where the CG shift scheme is implemented.

### Other Embodiments

The respective requirements described in the first, second, and other embodiments may be combined. Furthermore, the requirements described in the first, second, and other embodiments may be selectively used in accordance with a radio condition, a system requirement, and the like, for example.

Further, the shift amount (width) described in the first, second, and other embodiments may be replaced with a similar concept (time, unit time, timing, or frame, for example), other than the number of slots.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A first wireless communication device that performs pre-allocated communication to communicate with a second wireless communication device, using a preconfigured radio resource, the first wireless communication device comprising:
a controller configured to receive data transmitted on an adjusted radio resource obtained by adjusting a timing of a preconfigured pre-allocated radio resource to a predetermined different timing.

2. The first wireless communication device according to claim 1, wherein
the second wireless communication device transmits a control signal that indicates that the adjustment is to be performed on a radio resource individually allocated to the second wireless communication device, and
the controller receives the control signal.

3. The first wireless communication device according to claim 2, wherein
the adjustment is performed when the second wireless communication device is unable to transmit data on the pre-allocated radio resource.

4. The first wireless communication device according to claim 2, wherein,
when data is not able to be transmitted on the adjusted radio resource, the adjustment is further performed in the second wireless communication device.

5. The first wireless communication device according to claim 4, wherein
the second wireless communication device retransmits the control signal when the adjustment is further performed, and
the controller receives the control signal.

6. The first wireless communication device according to claim 4, wherein
the second wireless communication device does not retransmit the control signal when the adjustment is to be further performed, and
the controller recognizes that the adjustment is to be further performed when being unable to receive data on the adjusted radio resource.

7. The first wireless communication device according to claim 1, wherein
the controller configures a timing at which the adjusted radio resource is not able to be used.

8. The first wireless communication device according to claim 1, wherein
the adjustment includes using a radio resource obtained by shifting the pre-allocated radio resource backward in a time axis as the adjusted radio resource.

9. A second wireless communication device that performs pre-allocated communication to communicate with a first wireless communication device, using a preconfigured radio resource, the second wireless communication device comprising:
a second controller configured to:
adjust a timing of a preconfigured pre-allocated radio resource to a predetermined different timing,
transmit data on the adjusted radio resource, and
control execution of the pre-allocated communication.
